(19) United States
(12) Patent Application Publication
(10) Pub. No.: US 2008/0164675 A1
(43) Pub. Date: Jul. 10, 2008

(54) FOLDABLE BICYCLE

(76) Inventor: Pei-Chuan MA, Taipei City (TW)

Correspondence Address: LEONG C LEI, PMB # 1008, 1867 YGNACIO VALLEY ROAD, WALNUT CREEK, CA, 94598, US

(21) Appl. No.: 11/621,575

(22) Filed: Jan. 10, 2007

(51) Int. Cl. B62K 3/02

(52) U.S. Cl. 280/287

(57) ABSTRACT

A foldable bicycle is disclosed. The bicycle comprises a head tube having an upper end rotatably mounted with a handle and at an appropriate position of the lower section of the tube, a lug is fitted for connection to a crossbar, the upper portion of the lug provided with a hydraulic cylinder having one end linked to a connection seat for the mounting of a quick-release device, wherein the crossbar is linked to the lug of the head tube at one end, and another end of the sitting-pad is slightly bent with a short section mounted with a sleeve for securing a saddle, the front edge of the crossbar is mounted with a positioning for the quick-release device of the hydraulic cylinder, and a plurality of positioning holes are provided to the positioning device, and at the circumferential edge of the positioning holes, stepped recesses are formed such that the positioning holes are in communication with each other, and at the appropriate position of the lower edge of the crossbar, a tube lug is provided for the connection to a rear-wheel bar; the rear-wheel bar is inclined at an angle and is connected to the tube lug, a chainwheel is rotatably mounted at an appropriate position on the rear-wheel bar allowing the positioning of a pedal for use to cycle the bicycle, thereby the bicycle is foldable at the crossbar, and rear-wheel bar, facilitating shipping and storage of the bicycle.

### BACKGROUND OF THE INVENTION

(a) Technical Field of the Invention

The present invention relates to foldable bicycle, and in particular to a foldable bicycle which can be folded bicycle when the bicycle is not in use.

(b) Description of the Prior Art

Bicycle is a mean of transport device recently it has been encourage by government to enhance its usage. However, due to its rigid structure, it is not conveniently in storage and transporting, many people do not have the interest to use bicycle. Recently there are many foldable bicycles that available in the market, but their structure and complicated and the control is not simple, and therefore their usage is not popular. Accordingly, it is an object of the present invention to provide a foldable bicycle which mitigates the above drawbacks.

### SUMMARY OF THE INVENTION

The primary purpose of the present invention is to provide a foldable bicycle, in which the structure can be rapidly folded when it is not used, facilitating transporting and storage of the bicycle.

It is also an object of the present invention to provide a foldable bicycle comprising a head tube having an upper end rotatably mounted with a handle and at an appropriate position of the lower section of the tube, a lug is fitted for connection to a crossbar, the upper portion of the lug provided with a hydraulic cylinder having one end linked to a connection seat for the mounting of a quick-release device, wherein the crossbar is linked to the lug of the head tube at one end, and another end of the sitting-pad is slightly bent with a short section mounted with a sleeve for securing a saddle, the front edge of the crossbar is mounted with a positioning for the quick-release device of the hydraulic cylinder, and a plurality of positioning holes are provided to the positioning device, and at the circumferential edge of the positioning holes, stepped recesses are formed such that the positioning holes are in communication with each other, and at the appropriate position of the lower edge of the crossbar, a tube lug is provided for the connection to a rear-wheel bar; the rear-wheel bar is inclined at an angle and is connected to the tube lug, a chainwheel is rotatably mounted at an appropriate position on the rear-wheel bar allowing the positioning of a pedal for use to cycle the bicycle, thereby the bicycle is foldable at the crossbar, and rear-wheel bar, facilitating shipping and storage of the bicycle.

Still another object of the present invention is to provide a foldable bicycle, wherein a shock absorber is positioned between the crossbar and the rear-wheel bar, and a quick-release device is positions the shock absorber such that when the shock absorber is secured, a shock absorbing effect is provided, and when the shock absorber is not applied by releasing the quick-release device, the bicycle is foldable.

A further object of the present invention is to provide a foldable bicycle, wherein along the crossbar, adjacent to the shock-absorber, two symmetrical clipping members are mounted to accommodate the shock absorber after the bicycle is folded.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the foldable bicycle of the present invention.

FIG. 2 is an elevational view of the foldable bicycle of the present invention.

FIG. 3 is an exploded perspective view of the positioning device of the present invention.

FIG. 4 is a sectional view of the positioning device of the present invention.

FIG. 4A is a perspective exploded view of the shock absorber in accordance with the present invention.

FIG. 5 is a schematic view of the foldable bicycle of the present invention.

FIG. 6 is a schematic view of the foldable bicycle showing the adjustment of the angle of the head tube.

FIG. 7 is a schematic view showing the bicycle being folded in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

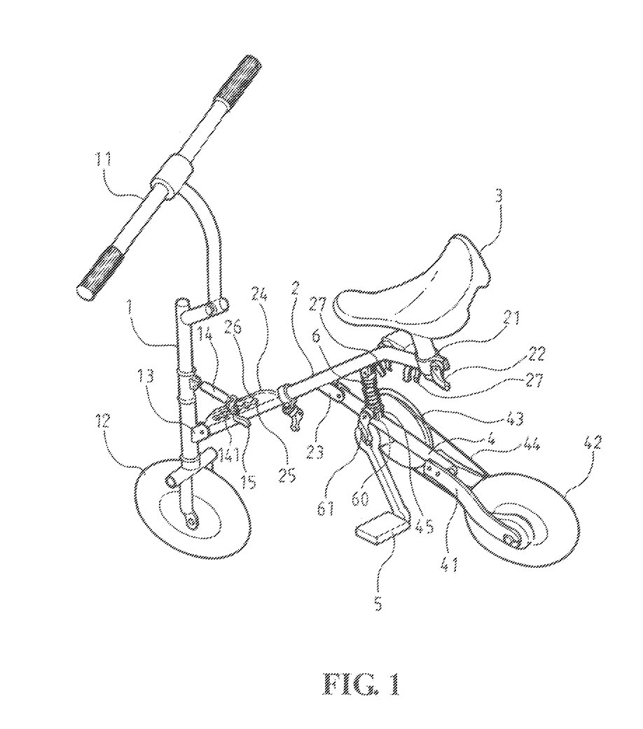

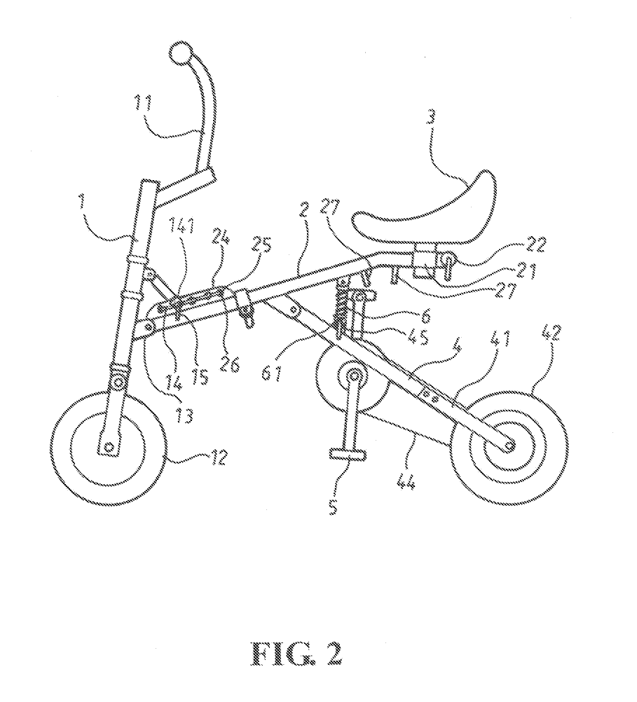

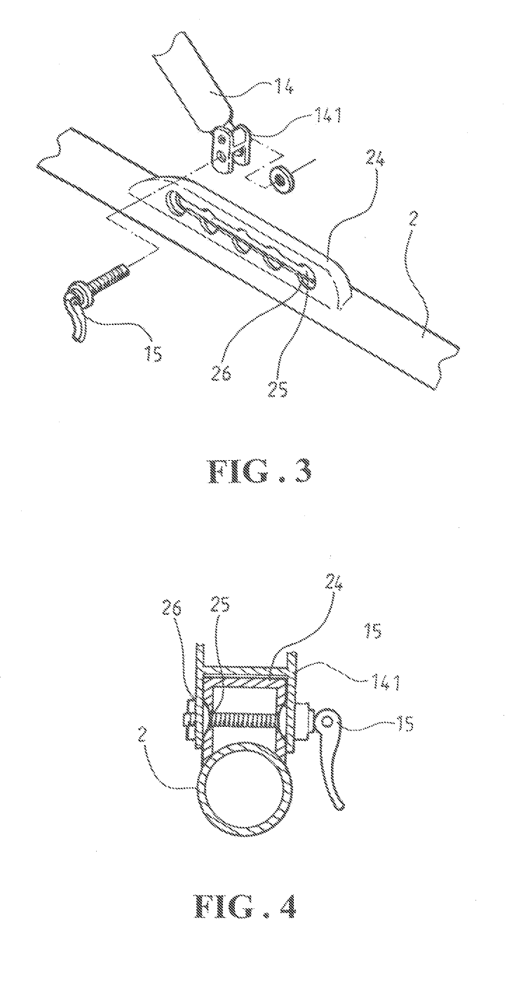

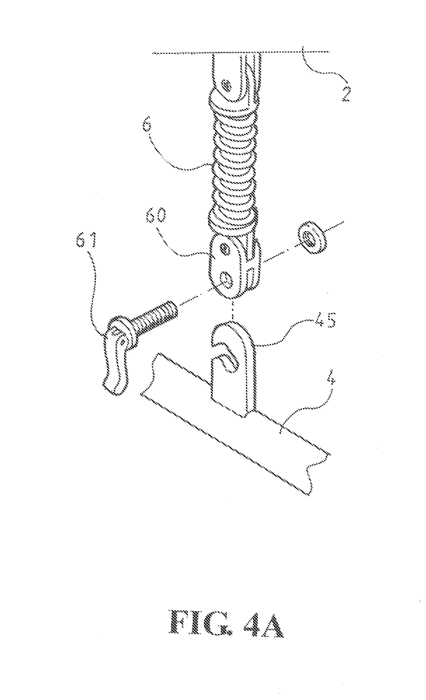

Referring to FIGS. 1, 2, 3, 4 and 4A, there is shown a foldable bicycle of the present invention comprising a head tube 1, a crossbar 2, a rear-wheel bar 4, a saddle 2 and a chainwheel 43 and pedals 5, a positioning device 24 and a hydraulic cylinder 14. The upper portion of the head tube 1 is rotatably mounted with a handle 1, which is slightly curved. The lower portion of the head tube 1 is mounted with a front wheel 12 and at an appropriate position on the head tube 1, a crossbar lug 13 is mounted and is for the linkage with the crossbar 2. The upper section of the lug 13 is positioned with the hydraulic cylinder 14 at one end, and the other end of the hydraulic cylinder 14 is a H-shaped connection seat 141 such that the connection seat 141 is actuating and is a positioning position for a rapid-release device 15.

The crossbar 2 is slightly inclined and the end section of the crossbar is slightly bent for the mounting of an opened sleeve 21. A quick-release device 22 is provided to the sleeve 21 such that after a saddle 3 is mounted to the crossbar 2 at the other end of the crossbar 2, the rapid-release device 22 is used to release or secure the crossbar so as to adjust the height of the saddle 3. At an appropriate position below the crossbar 2, a rear-wheel bar lug 2 is provided for the connection with the rear-wheel bar 4. The front edge of the rear-wheel bar 4 is provided with a positioning device 24 having a plurality holes 25, and the circumferential edge of the positioning hole 25 is formed into stepped recesses 26, which are in communication with the positioning holes 25 such that the hydraulic cylinder 14 is mounted to a different position of the positioning holes 25 by means of the engagement of the connection seat 141. The quick-release device 15 passes through the connection seat 141 and the positioning holes 25, and the quick-release device 15 is engaged at the recess 26.

The end section of the rear-wheel bar 4 is connected with a forked frame 41 for the mounting of a rear wheel 42. At an appropriate position of the rear-wheel bar 4, a chainwheel 43 is mounted, which is pivotally mounted to a pedal 5. The driving of the rear wheel 42 is controlled by pedaling the pedal 5, wherein by means of a chain 44, the rear wheel 42 is rotated.

A shock absorber 6 is connected between the slopped section of the crossbar 2 and the rear-wheel bar 4, and the bottom end of the shock absorber is a H-shaped connection seat 60 for the mounting quick-release device 61, at the upper edge or the adjacent of the chock absorber 6, a symmetrical clips 27 are provided such that the quick-release device 61 passes the connection seat 60, the shock absorber 6 is mounted at the lug 45 of the rear-wheel bar 4, or the absorber 6 is released from the two clips 27.

The crossbar 2 and the rear-wheel bar 4 are extended about the lugs 13 and 23, the bicycle according to the present invention can be recycled as normal bicycle. The hydraulic cylinder 14 and the shock absorber 6 are mounted when the bicycle is used. If the bicycle is not in use, the hydraulic cylinder 14 is positioned to the front-most position of the positioning device 24 and the shock absorber 6 is released, the crossbar 2 and the rear-wheel bar 4 are folded at the front direction, and the bicycle is thus folded, facilitating transporting and storage.

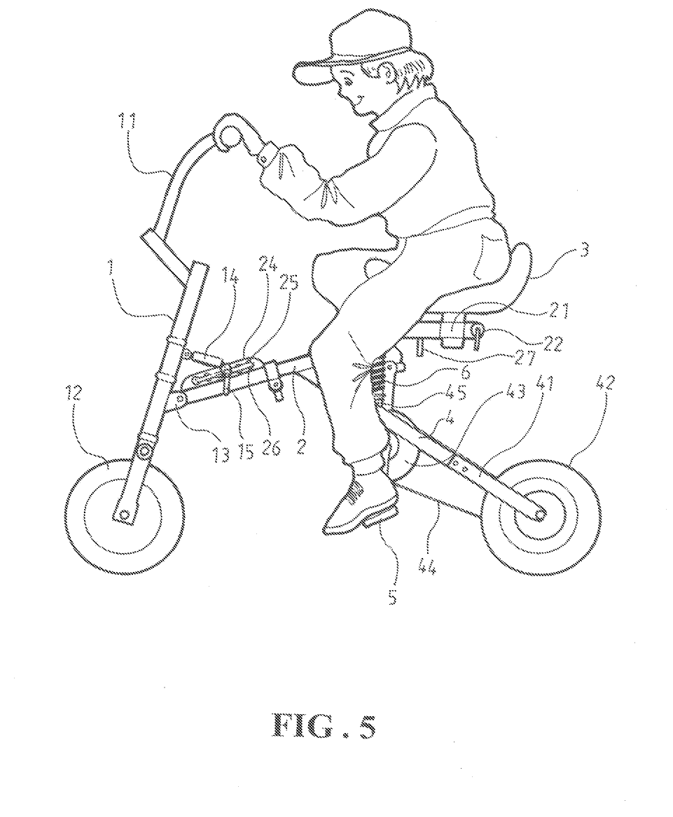

As shown in FIG. 5, when the bicycle is to be used. The crossbar 2 and the rear-wheel bar are extended outward about the lugs 13, 23 so that the bicycle can be used. The connection seat 141 of the hydraulic cylinder 14 is engaged at the positioning device 24 and the quick-release device 15 is used for mounting positioning device 24, and the shock absorber 6 is thus secured. Therefore, when the pedal 5 is pedaled by sitting on the saddle 3, the bicycle is moved forward. The handle 11 can be moved forward or backward to adjust the distance between the saddle 3 and the handle 11, and by securing the connection seat 141 of the hydraulic cylinder 14 at different position of the positioning hole 25, the bicycle is suitable for user of different sizes and height. The shock absorber 6 and the hydraulic cylinder 14 provide shock absorbing effect on a bumpy road, which provides a comfortable riding of the bicyclye.

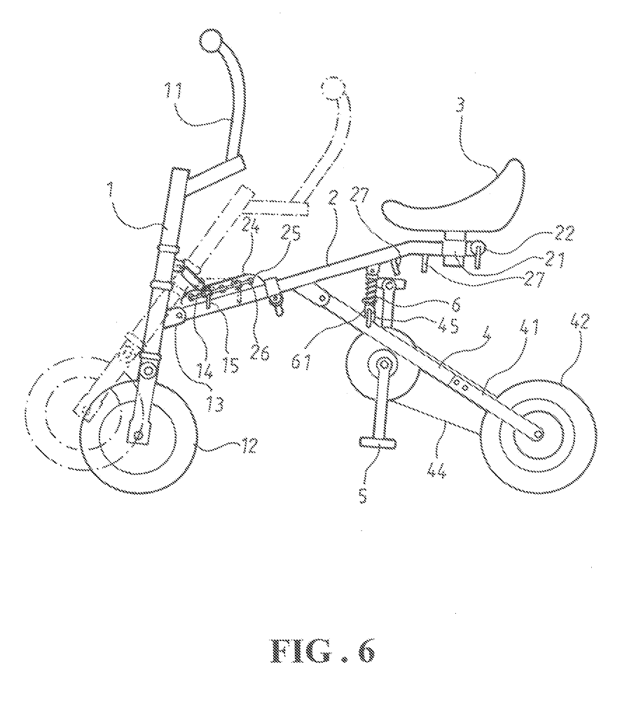

Referring to FIG. 6, when using the bicycle, the connection sent at the other end of the hydraulic cylinder 14 and the quick-release device 15 are positioned at front and rear position of the different positioning holes 25, and with the engagement of the release 26, the head tube 1 allows angle adjustment which enhances riding comfort of the bicycle.

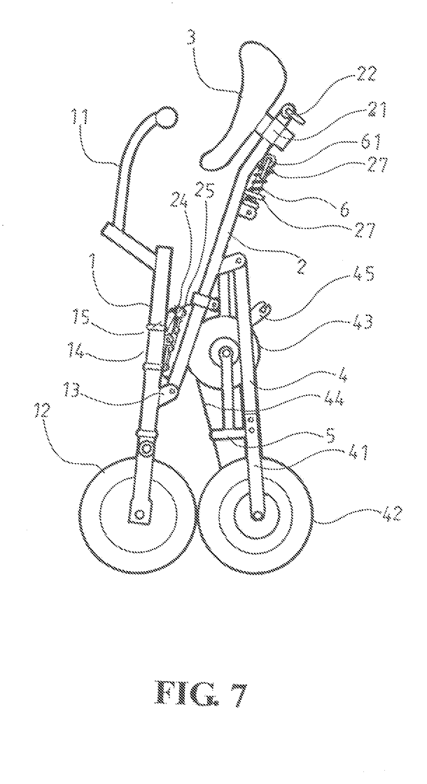

Referring to FIG. 7, when the bicycle is not in use, the bicycle can be folded as shown. The hydraulic cylinder 14 makes use of the quick-release device 15 such that it is positioned at the foremost end of the positioning hole 25 of the positioning device 24, and the shock absorber 6 makes use of the quick-release device 61 by releasing it from the two clips 27. The crossbar 2 is folded forward about the lug 13, and the rear-wheel bar 4 is folded downward about the lug 23. Thus, the folded bicycle is substantially an N-shaped structure. The space for storage is low, thus, the foldable bicycle of the present invention facilitates transporting and storage.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A foldable bicycle comprising
a head tube having an upper end rotatably mounted with a handle and at an appropriate position of the lower section of the tube, a lug is fitted for connection to a crossbar, the upper portion of the lug provided with a hydraulic cylinder having one end linked to a connection seat for the mounting of a quick-release device, wherein the crossbar is linked to the lug of the head tube at one end, and another end of the sitting-pad is slightly bent with a short section mounted with a sleeve for securing a saddle, the front edge of the crossbar is mounted with a positioning for the quick-release device of the hydraulic cylinder, and a plurality of positioning holes are provided to the positioning device, and at the circumferential edge of the positioning holes, stepped recesses are formed such that the positioning holes are in communication with each other, and at the appropriate position of the lower edge of the crossbar, a tube lug is provided for the connection to a rear-wheel bar; the rear-wheel bar is inclined at an angle and is connected to the tube lug, a chainwheel is rotatably mounted at an appropriate position on the rear-wheel bar allowing the positioning of a pedal for use to cycle the bicycle, thereby the bicycle is foldable at the crossbar, and rear-wheel bar, facilitating shipping and storage of the bicycle.

2. The foldable bicycle of claim 1, wherein a shock absorber is positioned between the crossbar and the rear-wheel bar, and a quick-release device is positions the shock absorber such that when the shock absorber is secured, a shock absorbing effect is provided, and when the shock absorber is not applied by releasing the quick-release device, the bicycle is foldable.

3. The foldable bicycle of claim 1, wherein along the crossbar, adjacent to the shock-absorber, two symmetrical clipping members are mounted to accommodate the shock absorber after the bicycle is folded.
